(19) United States
(12) Patent Application Publication
(10) Pub. No.: US 2006/0162200 A1
(43) Pub. Date: Jul. 27, 2006

(54) Number plate for hand-operated type and hand-operated type apparatus for number display device using the same

(76) Inventor: Yo-Wang Kim, Kangwon-do (KR)

Correspondence Address: BIRCH STEWART KOLASCH & BIRCH, PO BOX 747, FALLS CHURCH, VA, 22040-0747, US

(21) Appl. No.: 10/515,951

(22) PCT Filed: Jun. 22, 2002
(86) PCT No.: PCT/KR02/01190

§ 371 Date: Aug. 1, 2005

(30) Foreign Application Priority Data
May 29, 2002 (KR) 2002/29777

(51) Int. Cl. G09F 3/04

(52) U.S. Cl. 40/450

(57) ABSTRACT

This invention relates to a hand-operated number plate that is capable of displaying symbols such as number or alphabet etc with ease and a hand-operated number display device using the same. The hand-operated number plate according to an embodiment of the present invention includes a frame where formed openings of the shape of FIG. 8 with a tilt of 3˜8°, 7 segments corresponding to each unit section of the openings having the shape of FIG. 8, and a plurality of hinges combining each of the segments with the unit section of the opening to make it possible to revlove.

### BACKGROUND OF THE INVENTION

1. Field of the Invention

This invention relates to a hand-operated number display device, and more particularly to a hand-operated number plate that is capable of displaying symbols such as number or alphabet etc with ease and a hand-operated number display device using the same.

2. Description of the Related Art

A hand-operated number display device used for informing price at gas stations, railway stations or bus terminals generally displays a required figure replaced with other figure or a printed matter which is replaced with other where figures are printed. For this, a conventional hand-operated number display device requires a plurality of number plates. Because of this, there is disadvantage that it is hard to control for the number plates from 0 to 9 in the conventional hand-operated number display device.

On the other hand, a conventional automatic number display device displays figures by electrically controlling each segment that composes a number and is used in displaying exchange rate of banks. But, such automatic number display device has a disadvantage of requiring a separated power source for driving and its big fabrication cost.

### SUMMARY OF THE INVENTION

Accordingly, it is an object of the present invention to provide a hand-operated number plate that is capable of displaying symbols such as number or alphabet etc with ease and a hand-operated number display device using the same.

In order to achieve these and other objects of the invention, a hand-operated number plate according to an embodiment of the present invention includes a frame where there is formed an aperture of a shape of tilted “8” with a gradient of 3˜8°; seven segments respectively corresponding to each unit section of the aperture of the shape of “8”; and a plurality of hinges combining each segment with the unit section of the aperture with the capability of revolution.

A hand operated number display device according to another aspect of the present invention includes a plurality of number plates which has a plurality of basic boards on which a plurality of protrusions are arranged and formed in a matrix shape at its front and a plurality of combining bosses are formed at its rear; a plurality of combining blocks for commonly combining the basic boards with bosses formed at each of the different basic boards; and eight segments removably being combined with the basic board through front protrusions of the basic board and manually revolving at the front every unit section.

The hand operated number display device further includes a plurality of blank blocks combined through front protrusions of the combining board, where the basic board and the plurality of the basic boards are combined, and forming a flat surface of a blank on the basic board and the combining board; and a plurality of ribs combined through front protrusions of the combining board, where the basic board and the plurality of the basic boards are combined, for dividing a vertical direction and a horizontal direction within the basic board and the combining board.

In the hand operated number display device, each of 8 segments is respectively tilted by 3˜8° in the number plate.

In the hand operated number display device, each combining block includes a plurality of grooves removably combined with the bosses that are formed at each of the different basic boards.

In the hand operated number display device, the combining blocks includes a small combining block for commonly combining two basic boards which are different from each other; and a large combining block for commonly combining four basic boards which are different from one another.

In the hand operated number display device, the ribs includes: a vertical rib combined through front protrusions of the combining board where the basic board and the plurality of basic boards are combined, for dividing in vertical direction within the basic board and the combining board; and a horizontal rib combined through front protrusions of the combining board where the basic board and the plurality of basic boards are combined, for dividing in horizontal direction within the basic board and the combining board.

In the hand operated number display device, the vertical rib includes: a small section vertical rib combined through front protrusions of the combining board where the basic board and the plurality of basic boards are combined, for making vertical division into small section units within the basic board and the combining board; and a large section vertical rib combined through front protrusions of the combining board where the basic board and the plurality of basic boards are combined, for making vertical division into large section units within the basic board and the combining board.

In the hand operated number display device, the large section vertical rib includes: a head part of semicircular shape; a vertical supporter extended from the head part; and a plurality of grooves formed on the rear of the vertical supporter and combined through the front protrusions of the combination board where the basic board and the plurality of basic boards are combined.

In the hand operated number display device, the horizontal rib includes: a head part of semicircular shape; a vertical supporter extended from the head part with the same interval; and a plurality of grooves formed on the rear of the vertical supporter and combined through the front protrusions of the combination board where the basic board and the plurality of basic boards are combined.

In the hand operated number display device, printed matter, on which character string is printed, is stuck to the blank block.

### BRIEF DESCRIPTION OF THE DRAWINGS

These and other objects of the invention will be apparent from the following detailed description of the embodiments of the present invention with reference to the accompanying drawings, in which:

FIG. 1 is a front prospective view and a rear prospective view representing hand-operated number plate according to an embodiment of the present invention;

FIG. 2 is a disassemble prospective view representing the hand-operated number plate shown in FIG. 1;

FIG. 3 is a prospective view representing a hand-operated number display device according to an embodiment of the present invention;

FIG. 4 is a disassemble prospective view representing the hand-operated number display device shown in FIG. 3;

FIG. 5 is a front prospective view and a rear prospective view representing a big combination block shown in FIG. 4;

FIG. 6 is a front prospective view and a rear prospective view representing a small combination block shown in FIG. 3;

FIG. 7 is a prospective view representing a blank block shown in FIG. 3;

FIG. 8 is a front prospective view and a rear prospective view representing a horizontal rib shown in FIG. 3;

FIG. 9 is a front prospective view and a rear prospective view representing a small section vertical rib shown in FIG. 3;

FIG. 10 is a front prospective view and a rear prospective view representing a large section vertical rib shown in FIG. 3; and

FIG. 11 is a plane view representing a hand-operated number display device according to an embodiment of the present invention.

### DETAILED DESCRIPTION OF THE PREFERRED EMBODIMENT

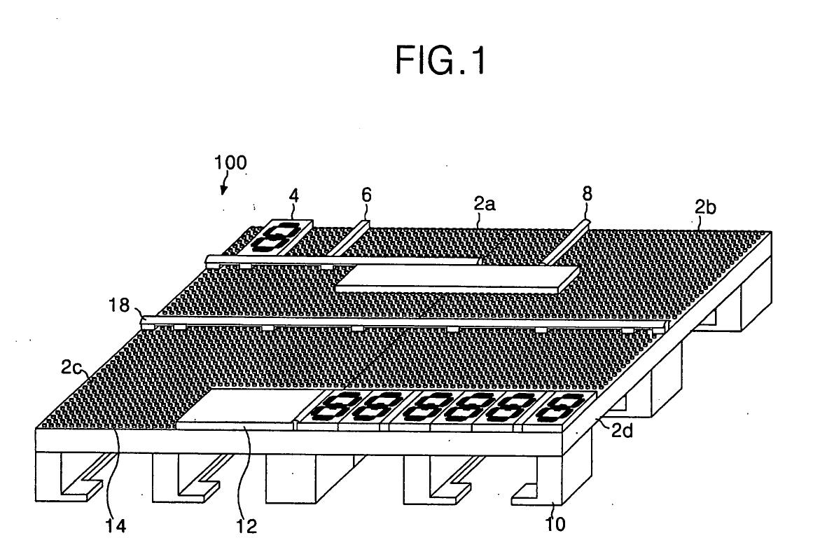

With reference to FIG. 1 to 11, there is explained a preferred embodiment of the present invention as follows.

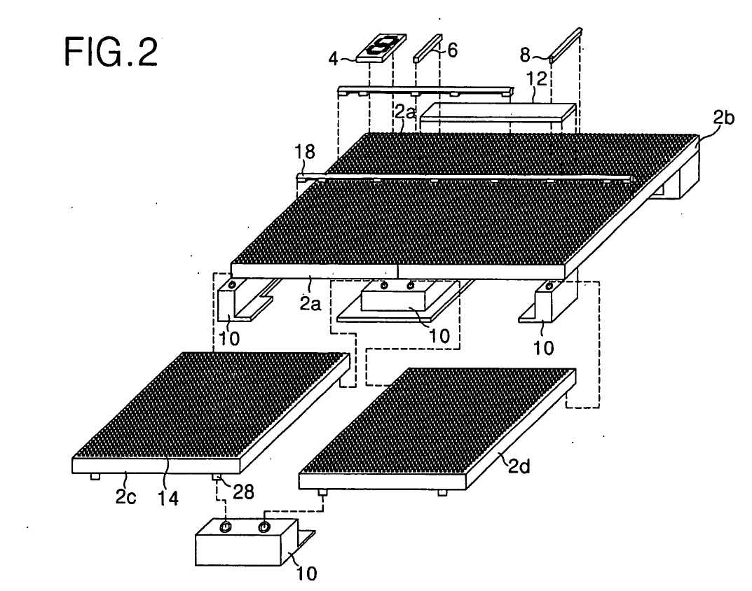

Referring to FIG. 1 and 2, a number plate 4 according to an embodiment of the present invention includes a frame 58 where formed openings 51 of the shape of figure “8” with a tilt of 3˜8°, 7 segments 60 corresponding to each unit section of the openings 51 having the shape of figure 8, and a plurality of hinges 57 combining each of the segments with the unit section of the opening to make it possible to revolve.

The openings 51 of the shape of figure “8” in the frame 58 has a tilt of approximate 3˜8° for preventing from the deterioration of a cognition characteristic by the visual characteristic of human being. This is because human cognition characteristics are higher in the digit and alphabet displayed with pre-determined tilt than in the digit and alphabet displayed vertically.

The edge of the frame 58 is vertically extended and angularly bent for covering the front surface and the side surface of the supplementary frame 67 to be assembled. Also, in the rear surface of the frame 58 are formed slit 63 to which a hinge 57 is inserted and protrusions 61 for combining the frame 58 with the supplementary frame 67.

The supplementary frame 67 has a revolution space 73 provided not to interfere each segment 60 upon the revolution of the segment 60 inserted into the slit 63 through the hinge 57. The revolution space 73 is provided by a protrusion member 75 projected to a specific height at the periphery of the revolution space 73. In the protrusion member 75 is formed a protrusion groove 65 into which a protrusion 61 of the frame 58. Accordingly, the frame 58 and the supplementary frame 67 are assembled to make the frame 58 have the opening 51 of the shape of figure “8”.

Also, a plurality of square protrusions 56 are projected at the rear of the supplementary frame 67, and a plurality of grooves 78 are formed at the rear of each square protrusion 56. The grooves 78 formed at each square protrusion 56 are combined with four protrusions 14 that are formed on a basic board 100 described later, and it can be removable.

Seven segments 60 are correspondingly combined with each unit section of the opening 51 of the shape of figure “8” formed at the frame 58 to display digit and alphabet. Each segment 60 has display part 52 and non-display part 54 divided by color. Herein, the display part 52 is applied with the color easily catching the eye and the non-display part 54 is in contact with means to revolve each segment 60. For instance, the display part 52 and the non-display part 54 can separately be provided in the lengthy direction at one side. The rear of such 7 segments 60 is applied with the same color as the upper frame 58.

Accordingly, the desired digit and alphabet can be displayed by the combination of the display part 52 provided with each segment 60. A wing part 69B for revolution of the segment 69A is extended from the center of the segment 69A, which is located at the central part among the seven segments 60. The wing part 69B contacts the means for revolution of the segment 69A.

The hinges 57 make each of segments 60 combined with the unit section of the opening 51 to make it possible that they revolve independently. Such hinges 57 are assembled in the way of penetrating the segments 60 in their lengthy direction. On the other hand, the hinges 57 can be formed in the manner of being projected from the side of each segment 60 with a specific length.

Such number plate 4 has the rear of the frame 58 face upward and the hinge 57 of each segment 60 inserted into the slit 63 formed on the frame 58. Then, there is inserted the supplementary frame 67, where the protrusion groove 65 is formed, to the protrusion 61 of the frame 58. Consequently, each segment 60 is inserted into the silt 63 of the frame, supported by the supplementary frame 67 and remains at the up-lifted state for being rotated in the revolution space 73. In this way, the digit and alphabet can manually be displayed by that each segment 60 in the state of being up-lifted in the revolution space 73 of the supplementary frame 67 is rotated by the press of the means being in contact with the non-display part 54.

Therefore, the hand-operated number plate 4 according to the embodiment of the present invention can improve the cognition characteristic of human being because each segment 60 displays digit and alphabet with a tilt of 3˜8°

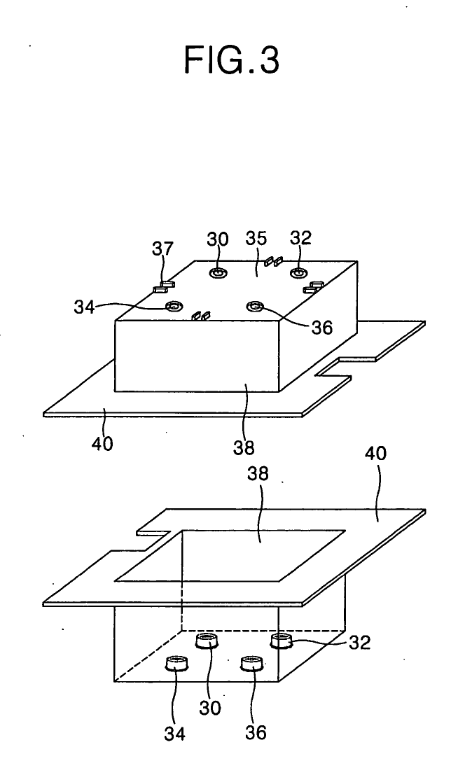

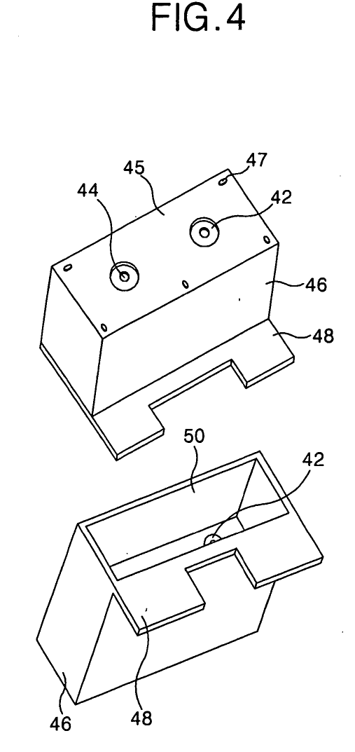

Referring to FIGS. 3 and 4, the hand-operated number display device according to the embodiment of the present invention includes a plurality of basic boards 2A, 2B, 2C and 2D where a plurality of protrusions 14 is formed by being arranged in a matrix shape at the front and a plurality of combining bosses 28 are formed at the rear, a plurality of combining blocks 10 and 16 for combining the basic boards 2a, 2b, 2c and 2d while being commonly combined to the bosses 28 that are formed each basic boards 2a, 2b, 2c and 2d, and a plurality of number plates 4 that are removably combined with the basic board 2a, 2b, 2c and 2d through the protrusions 14 formed on the front surface of the basic board 2a, 2b, 2c and 2d, and where eight segments are formed, which rotates in manual at every unit section in the whole surface.

The protrusions 14 are combined with the number plate 4, ribs 6, 8 and 18 described later, and a removable blank block 12.

Each of bosses 28 is formed at the edge of the rear of each of the basic boards 2a, 2b, 2c and 2d. The combining blocks 10 and 16 for the connection of each of the basic boards 2a, 2b, 2c and 2d to one another are removably combined with such bosses 28.

The combining blocks 10 and 16 can be categorized as a large combining block 16 and a small combining block 10 by the number of the basic boards 2a, 2b, 2c and 2d for combination.

The large combining block 16 is used for connecting the basic boards 2a, 2b, 2c and 2d to four adjacent basic boards 2a, 2b, 2c and 2d. Also, the large combining block 16 is used in the event of mounting the hand-operated number display device( not shown) to a packing case.

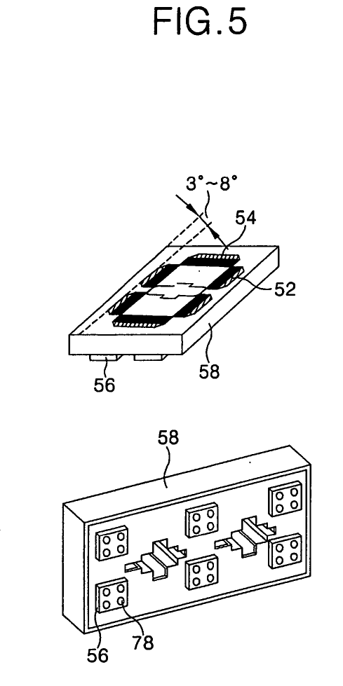

Such a large combining block 16 includes a vertical surface part 38 being projected with a predetermined height from a reference surface 40, as shown in FIG. 5, and a horizontal surface part 35 covering the end of the vertical surface part 38. The vertical surface part 38 is a tetrahedron of “T” shape projected from the reference surface 40. The inside of such a vertical surface part 38 is empty for reducing the weight of the large combining block 16.

Four circular grooves 30, 32, 34 and 36 that is inserted into each boss 28 of the basic boards 2a, 2b, 2c and 2d on the vertical surface part 35. Also, protrusions 37 projected with a predetermined height are formed for preventing movement of the basic boards 2a, 2b, 2c and 2d inserted into the circular groove 30, 32, 34 and 36 on the horizontal surface part 35. The protrusions 37 face with the side surface of the basic boards 2a, 2b, 2c and 2d.

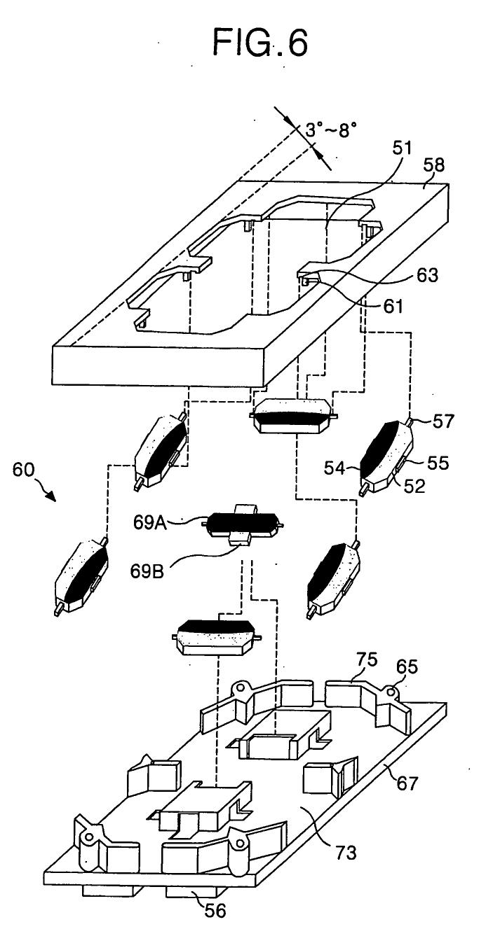

The small combining block 10 is used in the event of connecting the basic boards 2a, 2b, 2c and 2d to two adjacent basic boards 2a, 2b, 2c and 2d. Also, the small combining block 10 is used in the event of mounting the hand-operated number display device( not shown) to a packing case. Such a small combining block 10 includes a vertical surface part 46 being projected from a reference surface 48, as shown in FIG. 6, and a horizontal surface part 45 covering the end of the vertical surface part 46.

The inside of the vertical surface part 46 is empty for reducing the weight of the small combining block 10. Two circular grooves 42 and 44 that is inserted into each boss 28 of the basic boards 2a, 2b, 2c and 2d on the vertical surface part 45. Also, protrusions 47 projected with a predetermined height are formed for preventing movement of the basic boards 2a, 2b, 2c and 2d inserted into the circular groove 42, and 44 on the horizontal surface part 45. The protrusions 47 face with the side surface of the basic boards 2a, 2b, 2c and 2d. Such a small combining block 10 becomes the shape of “L” projected from the reference surface 48.

The large combining block 16 and the small combining block 10 have four basic boards 2a, 2b, 2c and 2d connected to one another to make a combination board 100. On the other hand, the size of the combination board 100 is determined by the number of the basic boards connected in accordance with a figure and alphabet etc that is to be displayed. That is, the size of the combination board 100 depends on the figure and the alphabet etc to be displayed.

Character string such as figure and alphabet etc is displayed on the protrusions 14 of the combination board 100 to which four basic boards 2a, 2b, 2c and 2d. For this, the hand-operated number display device according to the embodiment of the present invention further includes a plurality of blank blocks 12, which is combined through the front protrusions 14 of the combination board 100 where the basic boards 2a, 2b, 2c and 2d and a plurality of the basic boards 2a, 2b, 2c and 2d, having a blank flat surface formed on the basic boards 2a, 2b, 2c and 2d and the combination boards 100, and a plurality of ribs 6, 8 and 18, which is combined through the front protrusions 14 of the combination board 100 where the basic boards 2a, 2b, 2c and 2d and a plurality of the basic boards 2a, 2b, 2c and 2d, for partitioning vertical directions and horizontal directions in the basic boards 2a, 2b, 2c and 2d and the combination boards 100.

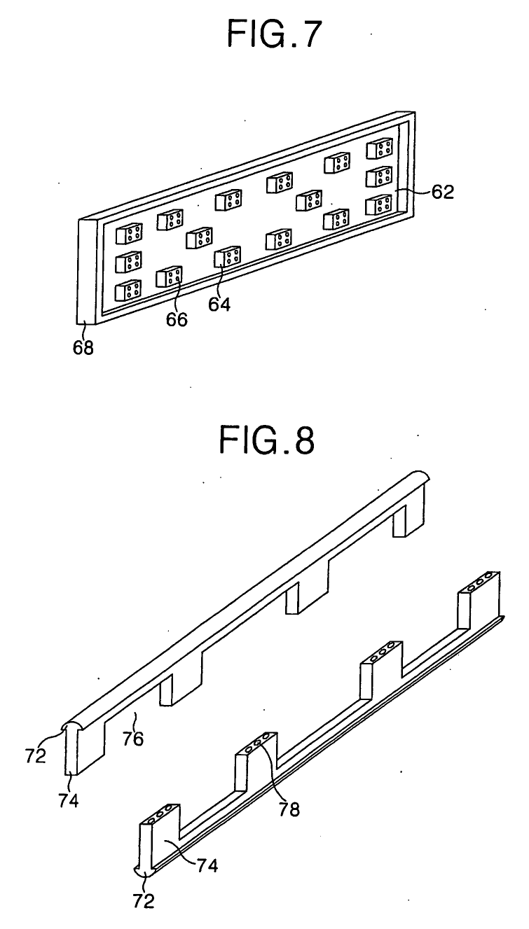

The blank block 12 includes a flat frame 68 having a blank flat surface as shown in FIG. 7, a square protrusion part 64 formed in the rear of the flat frame 68 with a predetermined gap, and a plurality of holes 66 formed at the rear of the square protrusion part 64.

The edge of the flat frame 68 is perpendicularly bent rectangular with the same height as the number plate 4. The square protrusion part 64 is projected with a predetermined height from the rear 62 of the flat frame 68 and has more height than rectangularly bent flat frame 68. Such a square protrusion part 64 is formed in a group of a specific number. For example, three square protrusion parts 64 are formed at the both ends of the rear 62 of the flat frame 68 with a predetermined gap therebetween, and 5 of them in a group is formed at the other area.

The four protrusions 14 formed on the combination board 100 are inserted-into the plurality of the holes 66 formed at each projected square part 64.

Like this, the blank block 12 is inserted between segment blocks 4 displayed on the combination board 100 to divide character strings or number strings or to display blank space. Also, the printed matter( not shown), where character strings such as Korean, Japanese and English, is stuck to a flat frame 68 of the blank block 12 to display the character string.

The ribs 6, 8 and 18 include a horizontal rib 18 for horizontally dividing within the basic boards 2a, 2b, 2c and 2d and the combination board 100 by being combined through the front protrusions 14 of the combination board 100 where the basic boards 2a, 2b, 2c and 2d and a plurality of the basic boards 2a, 2b, 2c and 2d are combined, and vertical ribs 6 and 8 for vertically dividing within the basic boards 2a, 2b, 2c and 2d and the combination board 100 by being combined through the front protrusions 14 of the combination board 100 where the basic boards 2a, 2b, 2c and 2d and a plurality of the basic boards 2a, 2b, 2c and 2d are combined.

The horizontal rib 18 includes a head part 72 of a semicircular shape with a specific length as shown in FIG. 8, a vertical supporter 74 perpendicularly extended to the head part 72, and a plurality of grooves formed at the rear of the vertical supporter 74.

The head part 72 of the vertical supporter 54 partly covers the edge of the number plate 4 and the blank block 12. The vertical supporter 74 has the same thickness as the blank block 12 and the number plate 4. The grooves 78 formed at each vertical supporter 54 are removably combined to the protrusions 14 formed on the combination board 100. Such a vertical supporter 54 is extended with the same interval from the heading part 72 for providing convenience when combining the protrusions 14 of the combination board 100.

Such a horizontal rib 18 horizontally divides within the basic boards 2a, 2b, 2c and 2d and the combination board 100 by being combined through the front protrusions 14 of the combination board 100 where the basic boards 2a, 2b, 2c and 2d and a plurality of the basic boards 2a, 2b, 2c and 2d are combined, or partitions between the number plate 4 and the blank block 12.

The vertical rib 6 and 8 includes a small section vertical rib 6 for vertically dividing by small sections within the basic boards 2a, 2b, 2c and 2d and the combination board 100 by being combined through the protrusions 14 formed on the front surface of the combination board 100 where the basic boards 2a, 2b, 2c and 2d and a plurality of the basic boards 2a, 2b, 2c and 2d are combined, and a large section vertical rib 8 for vertically dividing by large sections within the basic boards 2a, 2b, 2c and 2d and the combination board 100 by being combined through the protrusions 14 formed on the front surface of the combination board 100 where the basic boards 2a, 2b, 2c and 2d and a plurality of the basic boards 2a, 2b, 2c and 2d are combined.

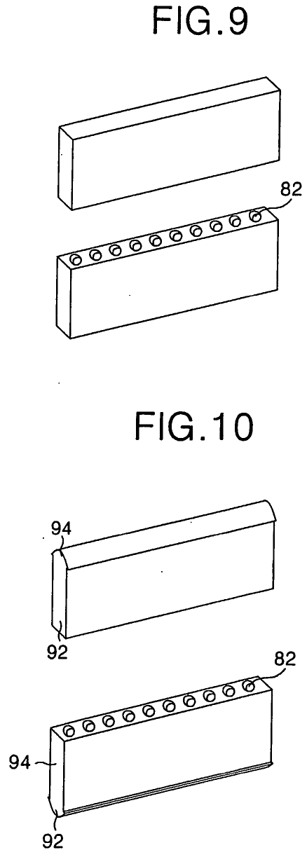

The small section rib 6 has its length same as the vertical size of the number plate 4 and the blank block 12 as shown in FIG. 9, and the same thickness as the number plate and the blank block 12. A plurality of grooves 82 are formed in a row at the rear of the small section rib 6 to make it removably combined to the protrusions 14 formed on the combination board 100.

Like this, the small section rib 6 vertically divides within the basic boards 2a, 2b, 2c and 2d and the combination board 100 by being combined through the front protrusions 14 of the combination board 100 where the basic boards 2a, 2b, 2c and 2d and a plurality of the basic boards 2a, 2b, 2c and 2d are combined, or partitions between the number plate 4 and the blank block 12.

The large section rib 8 includes a head part 92 of a semicircular shape with a specific length as shown in FIG. 10, a vertical supporter 94 extended with a specific height from the head part 92, and a plurality of grooves 96 formed in a row at the rear of the vertical supporter 94.

The head part 92 of the vertical supporter 94 covers the part of the edge of the number plate 4 and the blank block 12. The vertical supporter 94 has it height same as the thickness of the blank block 12 and the number plate 4. The grooves 96 formed at each vertical supporter 94 are removably combined with the protrusions 14 formed on the combining board 100.

Like this, the large section rib 8 vertically divides within the basic boards 2a, 2b, 2c and 2d and the combination board 100 by being combined through the front protrusions 14 of the combination board 100 where the basic boards 2a, 2b, 2c and 2d and a plurality of the basic boards 2a, 2b, 2c and 2d are combined, or partitions between the number plate 4 and the blank block 12.

The hand operated number display device according to the embodiment of the present invention has a number plate 4 for displaying number or alphabet and a blank block 12 for displaying character string, alphabet or blank inserted into the protrusions 14 on the combination board 100 to which a plurality of basic boards 2a, 2b, 2c and 2d are connected by a small combination block 10 and a large combination block 16. Accordingly, the character string and the number string are combined and displayed on the combination block 100.

Such character string and number string are divided by the small section rib 6 and the large section rib 8. Also, a horizontal rib 18 divides the character string or number string of one row and the character string or number string of the next row. The blank block 12 is inserted in the event of displaying blank between character strings. Or character string or alphabet, which cannot be displayed with the number plate 4, can be displayed by sticking the printed matter of the wanted character string or alphabet onto the blank block 12.

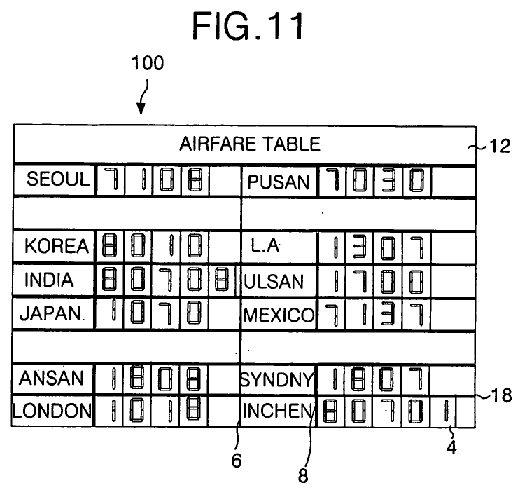

Like this, the character string or number string displayed on the combination board 100 is displayed as shown in FIG. 11.

Referring to FIG. 11, the blank block 12 and the number plate 4 are combined to display airfare by countries and cities on the combination board 100. To describe this more particularly, the printed matter (not shown) on which the name of country and city is printed is stuck onto the blank block 12.

Then, the blank block 12, which the name of country and city is stuck to, is inserted into one side of the combination board 100 to be arranged, and a plurality of number plates 4 are arranged along the blank block 12 to which the name of country and city is stuck. That is, the character strings such as Korean, Japanese and English etc are displayed by sticking the printed matter to the blank block 12, and number strings are displayed by combining the digits obtained when revolving each of the segments of a plurality of the number plates 4. At this moment, the small section rib 6 or the large section rib 8 are inserted between the character string and the number string displayed on the combination board 100 to divide the character string and the number string. Also, the horizontal rib 18 is inserted between horizontal rows on the combination board 100 where the character string and the number string is combined to divide the horizontal rows.

The blank block 12 onto which the name of country and the name of city are stuck, and a plurality of number plates 4 are combined and disposed on the combination board 100 to display airfare by countries or by cities.

On the other hand, a price list of gas station and the price list of bus terminal etc can be displayed on the combination board 100.

As described above, the hand operated number plate according to the embodiment of the present invention tilts the segment “8” with the gradient of 3˜8° C. to increase human perception characteristics.

Also, the hand operated number display device according to the embodiment of the present invention displays the segment block and the character string for displaying number and alphabet on the combination board, where a plurality of basic board are combined, to easily combine the character and the number for displaying.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A hand operated number plate, comprising:
a frame where there is formed an aperture of a shape of tilted “8” with a gradient of 3˜8°;
seven segments respectively corresponding to each unit section of the aperture of the shape of “8”; and
a plurality of hinges combining each segment with the unit section of the aperture with the capability of revolution.

2. A hand operated number display device, comprising a plurality of number plates, which includes:
a plurality of basic boards on which a plurality of protrusions are arranged and formed in a matrix shape at its front and a plurality of combining bosses are formed at its rear;
a plurality of combining blocks for commonly combining the basic boards with bosses formed at each of the different basic boards; and
eight segments removably being combined with the basic board through front protrusions of the basic board and manually revolving at the front every unit section.

3. The hand operated number display device according to claim 2, further comprising:
a plurality of blank blocks combined through front protrusions of the combining board, where the basic board and the plurality of the basic boards are combined, and forming a flat surface of a blank on the basic board and the combining board; and
a plurality of ribs combined through front protrusions of the combining board, where the basic board and the plurality of the basic boards are combined, for dividing a vertical direction and a horizontal direction within the basic board and the combining board.

4. The hand operated number display device according to claim 2, wherein each of 8 segments is respectively tilted by 3˜8° in the number plate.

5. The hand operated number display device according to claim 2, wherein each combining block includes a plurality of grooves removably combined with the bosses that are formed at each of the different basic boards.

6. The hand operated number display device according to claim 2, wherein the combining blocks includes:
a small combining block for commonly combining two basic boards which are different from each other; and
a large combining block for commonly combining four basic boards which are different from one another.

7. The hand operated number display device according to claim 3, wherein the ribs includes:
a vertical rib combined through front protrusions of the combining board where the basic board and the plurality of basic boards are combined, for dividing in vertical direction within the basic board and the combining board; and
a horizontal rib combined through front protrusions of the combining board where the basic board and the plurality of basic boards are combined, for dividing in horizontal direction within the basic board and the combining board.

8. The hand operated number display device according to claim 7, wherein the vertical rib includes:
a small section vertical rib combined through front protrusions of the combining board where the basic board and the plurality of basic boards are combined, for making vertical division into small section units within the basic board and the combining board; and
a large section vertical rib combined through front protrusions of the combining board where the basic board and the plurality of basic boards are combined, for making vertical division into large section units within the basic board and the combining board.

9. The hand operated number display device according to claim 8, wherein the large section vertical rib includes:
a head part of semicircular shape;
a vertical supporter extended from the head part; and
a plurality of grooves formed on the rear of the vertical supporter and combined through the front protrusions of the combination board where the basic board and the plurality of basic boards are combined.

10. The hand operated number display device according to claim 7, wherein the horizontal rib includes:
a head part of semicircular shape;
a vertical supporter extended from the head part with the same interval; and
a plurality of grooves formed on the rear of the vertical supporter and combined through the front protrusions of the combination board where the basic board and the plurality of basic boards are combined.

11. The hand operated number display device according to claim 3, wherein printed matter, on which character string is printed, is stuck to the blank block.
